(19) United States
(12) Patent Application Publication
(10) Pub. No.: US 2007/0267785 A1
(43) Pub. Date: Nov. 22, 2007

(54) Composite Pipe Lining and Method and Apparatus for Installing a Composite Lining

(76) Inventors: Norman West Bellamy, Coventry (GB); Neil Michael Bellamy, Coventry (GB)

Correspondence Address: YOUNG LAW FIRM, P.C.;ALAN W. YOUNG, 4370 ALPINE ROAD, SUITE 106, PORTOLA VALLEY, CA, 94028, US

(21) Appl. No.: 10/599,051

(22) PCT Filed: Mar. 15, 2005
(86) PCT No.: PCT/GB05/00968

§ 371 Date: May 14, 2007

(30) Foreign Application Priority Data
Mar. 18, 2004 (GB) 0406084.4
Aug. 13, 2004 (GB) 0418084.0
Sep. 28, 2004 (GB) 0421508.3

(51) Int. Cl. B29C 45/00; A23G 1/22; B23K 11/06

(52) U.S. Cl. 264/512; 219/82; 425/112

(57) ABSTRACT

A composite lining for a pipe comprising a structural layer for providing structural integrity and a containment layer for providing fluid impermeability. The structural layer comprising at least one strip of lining material arranged to form a substantially continuous lining within said pipe. A method for lining a pipe with said composite lining. A structure and method for testing the fluid integrity of said containment layer. Apparatus for installing said structural and containment layers in said pipe.

The present invention relates to a composite lining for a pipe, a method of installing a composite lining and apparatus for Installing a composite lining.

Leakage from pipes is a major problem, well known to gas and water authorities. The problem is compounded by the expense of and disruption caused by rectifying leaks when they occur, by repair or replacement of the defective gas, water and sewage pipes. Leakage is a particular issue for gas pipes, where any leak is dangerous, and for water pipes where leakage typically accounts for an average loss of over 30% between reservoir and tap. Many pipelines are in need of refurbishment and the authorities generally seek long term solutions rather than piecemeal repairs.

One solution for prolonging the life of existing pipes is to re-line them using an appropriate material. Thermoplastics such as polyethylene, for example, are the current preferred materials for relining the gas and water networks and can have design lifetimes in excess of 50 years and expected lifetimes of significantly longer. A number of pipe lining methods are available for lining small and medium diameter pipes but these are not generally applicable for the lining of larger diameter pipes. This lack of suitable lining methods means that expensive replacement solutions often have to be implemented when large diameter pipes are in need of maintenance.

In general, pipelining systems use application specific materials and lining systems suited to the requirements of the pipe system and any associated regulatory requirements. Linings for gas pipes, where gas containment is paramount, for example, commonly use standard or specialist polyethylene pipes, which often require temporary deformation, to allow insertion into the typically cast iron host pipes. However, these structural ‘sliplining’ techniques require large street footprints during installation to accommodate the assembled lining pipe, and large access pits to allow insertion to take place without damaging the lining pipes. The current sliplining methods are also impractical for large diameter pipes of, for example, 24 inches and above. Furthermore, there are no generally accepted methods for lining larger gas pipes up to 48 inches diameter and higher.

For water pipes, strict drinking water regulations have led to cement mortar linings being replaced by spray-on resin linings to prevent corrosion and leakage. Polyethylene sliplining techniques are also used to provide long term structural solutions. Cured-in-place polyester resin linings are popular for gravity sewer pipes where host pipe deformity and external water pressure are particular problems, and regulation is less restrictive. Nevertheless, in both the water and sewer pipe industries, the lining of large diameter pipes is both difficult and expensive and hence new or alternative solutions are highly desirable.

Additionally, many pipelines are not straight and have internal irregularities such as joints, projecting lateral connections and misaligned pipe sections. In such pipes, thin walled liners made from flat sheet have been proposed. These, however, have a tendency to kink, buckle or deform in other undesirable ways when forced, under pressure, to deform to the internal shape of the pipeline.

The present invention provides a composite lining for a pipe, and a method of installing a composite lining, which seeks to mitigate the above issues.

According to a first aspect of the invention there is provided a composite lining for a pipe comprising: a structural layer for providing structural integrity; and a containment layer for providing fluid impermeability; wherein, the structural layer comprises at least one strip of lining material arranged to form a substantially continuous lining within said pipe.

Preferably the containment layer may comprise at least one section of lining material arranged to form a substantially continuous impermeable tubular lining within said pipe.

The containment layer may be provided concentrically within the structural layer, the containment layer may be bonded to at least a portion of an internal surface of the structural layer.

The containment layer may be provided concentrically outside the structural layer.

Preferably the structural layer comprises a strip helically wound to form a plurality of turns, each turn being in substantial helical contact with the previous turn thereby forming a substantially continuous tubular lining within said pipe.

The structural layer may be a first structural layer, and the composite lining may be provided with a further structural layer, the further layer comprising at least one strip of lining material arranged to form a substantially continuous lining within said pipe.

The further structural layer may comprise a strip helically wound to form a plurality of turns, each turn being in substantial helical contact with the previous turn thereby forming a substantially continuous tubular lining within said pipe.

Preferably, the first structural layer is provided concentrically within the further structural layer.

Preferably the first structural layer comprises a strip helically wound in a first helical direction to form a substantially continuous tubular lining within said pipe; and the further structural layer comprises a strip helically wound in a second helical direction to form a substantially continuous tubular lining within said pipe; and wherein, the first and second helical directions are opposite.

Preferably the containment layer is a first containment layer, and the composite lining is provided with a further containment layer, the further containment layer comprising at least one section of lining material arranged to form a substantially impermeable tubular lining within said pipe.

The or at least one structural layer may be provided between the first and further containment layers.

The composite lining may comprise at least three containment layers and at least two structural layers, the containment layers being separated from one another by a corresponding structural layer.

According to another aspect of the invention there is provided a method of lining a pipe comprising: lining said pipe with a structural layer for providing structural integrity; and lining said pipe with a containment layer for providing fluid impermeability; wherein, lining said pipe with a structural layer comprises arranging said structural layer to form a substantially continuous lining within said pipe.

Preferably lining said pipe with said containment layer comprises arranging at least one section of lining material to form a tubular lining and seaming said tubular lining to render it substantially impermeable.

Preferably lining said pipe with a structural layer comprises helically winding a strip to form a plurality of turns, each turn being in substantial helical contact with the previous turn thereby forming a substantially continuous tubular structural layer within said pipe.

The containment layer may be provided concentrically outside the structural layer.

Preferably the structural layer is a first structural layer, and the method further comprises lining the pipe with a further structural layer, the further layer comprising at least one strip of lining material arranged to form a substantially continuous lining within said pipe.

Preferably lining said pipe with said further structural layer comprises helically winding a further strip to form a plurality of turns, each turn being in substantial helical contact with the previous turn thereby forming a substantially continuous tubular structural layer within said pipe.

Preferably lining the pipe with a first structural layer comprises helically winding a strip in a first helical direction to form a substantially continuous tubular lining within said pipe; and lining the pipe with the further structural layer comprises helically winding further strip in a second helical direction to form a substantially continuous tubular lining within said pipe; wherein, the first and second helical directions are opposite.

Preferably the containment layer is a first containment layer, and the method further comprises lining the pipe with a further containment layer by arranging at least one further section of lining material to form a tubular lining and seaming said tubular lining to render it substantially impermeable.

Preferably the method further comprises lining the pipe with at least three containment layers and at least two structural layers, the containment layers being separated from one another by a corresponding structural layer.

According to a further aspect of the invention there is provided a test structure for testing the fluid impermeability of a tubular containment layer of a composite lining according to the first aspect comprising: a seam along a longitudinal length of said containment layer, the seam comprising at least two substantially parallel seamed regions; and a conduit formed between said seamed regions.

According to a further aspect of the invention there is provided a method for testing the fluid impermeability of a tubular containment layer of a composite lining according to the first aspect comprising: providing said containment layer with a seam along a longitudinal length of said containment layer, the seam comprising at least two substantially parallel seamed regions; and a conduit formed between said seamed regions; pressurising said conduit with a fluid; determining if said fluid is leaking from either of said parallel seamed regions.

According to a further aspect of the invention there is provided an apparatus for providing a loosely twisted helical strip of lining material for lining a pipe, the apparatus comprising: a base portion; and coil support means rotatably mounted on said base portion for supporting a coil of said lining material and for allowing a strip of said lining material to be dispensed from said coil; the coil support means being rotatable in a controlled manner relative to said base portion for inducing helical twists in said strip of lining material.

Preferably said coil support means is configured to dispense said strip from a centermost end of said coil, thereby allowing a strip with a naturally induced helical twist to be dispensed; said naturally induced twist being additional to any rotation induced twist.

Preferably said coil support means is provided with a strip dispensing portion comprising an aperture for dispensing said strip through; said strip dispensing platform being rotatable independent of said coil support means relative to said base portion.

Preferably said coil support means is rotatably mounted on said base portion for rotation about the axial centre of said coil.

Preferably said coil support means is rotatably mounted on said base portion for rotation about an axis substantially perpendicular to the axial centre of said coil.

According to a further aspect of the invention there is provided an apparatus for helically lining a pipe with a strip of lining material, the apparatus comprising: a winding rig comprising helical winding means; said helical winding means being configured for helically winding said strip into a helically wound lining layer for lining an inside surface either of said pipe or of a previously laid lining layer.

Preferably said winding means is configured for helically winding said strip directly onto said inside surface; and said winding rig is configured for longitudinal travel along said pipe as each turn of said helically wound lining layer is formed on said inside surface.

Preferably said winding means is configured for helically winding said strip directly onto said inside surface; and said winding rig is configured for free rotation about a longitudinal axis of said pipe as each turn of said helically wound lining layer is formed on said inside surface.

Preferably said winding means is configured for winding said lining strip into a helically wound portion layer, and for driving said helically wound tubular portion along said pipe thereby to form said helically wound lining layer on said inside surface.

Preferably said winding means comprises: a cylinder rotatably mountable on an end of said pipe for winding said lining strip onto an internal surface thereof thereby to form said helically wound portion; and a helical guide mounted on said internal cylinder surface for driving said helically wound portion along said pipe thereby to form said helically wound lining layer on said inside surface either of said pipe or of a previously laid lining layer.

According to a further aspect of the invention there is provided an apparatus for lining a pipe with a tubular containment layer comprising: a formation portion comprising at least one rounding die for forming a sheet of lining material into a substantially cylindrical tubular structure.

Preferably the formation portion further comprises: at least one formation die for forming a sheet of lining material into a flattened tubular structure; the rounding die being located for forming said flattened tubular structure into said substantially cylindrical tubular structure.

According to a further aspect of the invention there is provided a welding apparatus for seam welding a containment layer in a pipe the apparatus comprising: a mobile unit configured for longitudinal travel down said pipe; said mobile unit comprising at least one seam welding head for welding a seam of said containment layer.

Preferably the mobile unit further comprises at least one further welding head for welding said containment layer to an underlying structural layer.

Preferably the or each welding head comprises an infra-red source for inducing heat thereby to cause said welding.

Preferably the or each welding head comprises an ultrasound source for inducing heat thereby to cause said welding.

Preferably the or each seam welding head includes a pressurising fan for applying air pressure to said seam during welding.

Preferably the or each seam welding head comprises a shield portion for preventing a longitudinal portion of said seam from being welded, thereby to form a fluid impermeable conduit.

Preferred embodiments of the invention will now be described by way of example only with reference to the accompanying drawings in which:

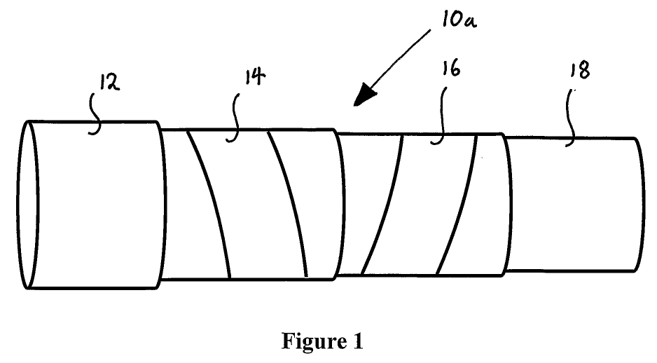

FIG. 1 shows a cutaway view of a first embodiment of a composite lining, within a host pipe;

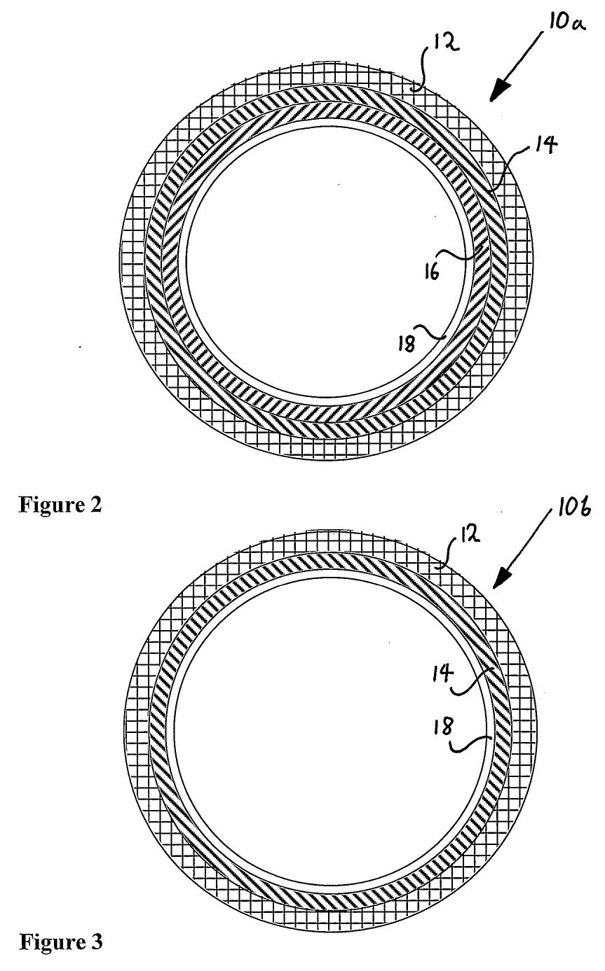

FIG. 2 is a cross section of the first embodiment;

FIG. 3 is a cross section of a second embodiment of a composite lining within a host pipe;

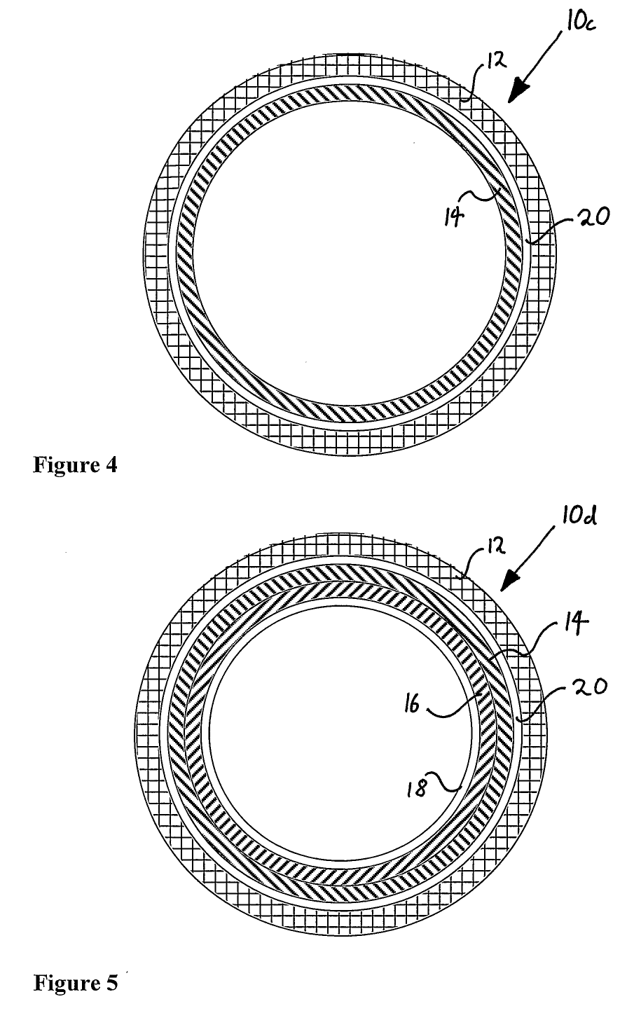

FIG. 4 is a cross section of a third embodiment of a composite lining within a host pipe;

FIG. 5 is a cross section of a fourth embodiment of a composite lining within a host pipe;

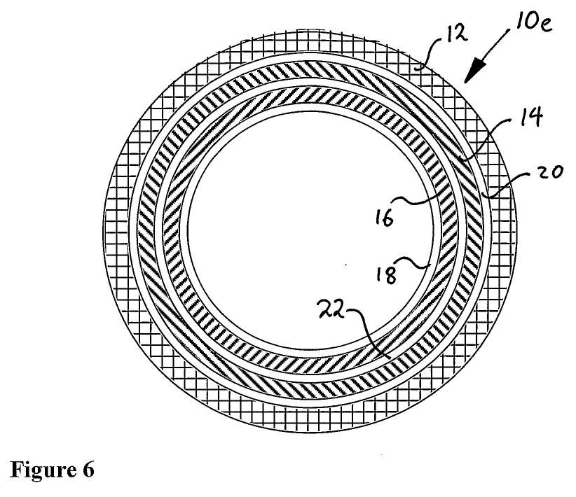

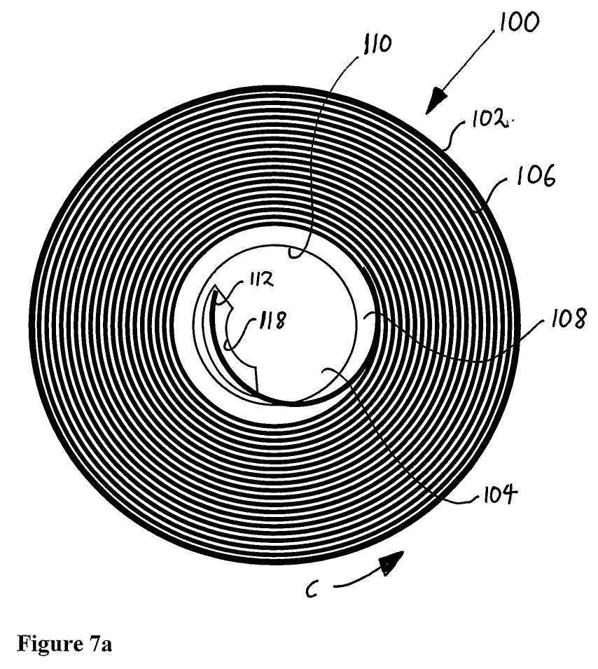

FIG. 6 is a cross section of a fifth embodiment of a composite lining within a host pipe;

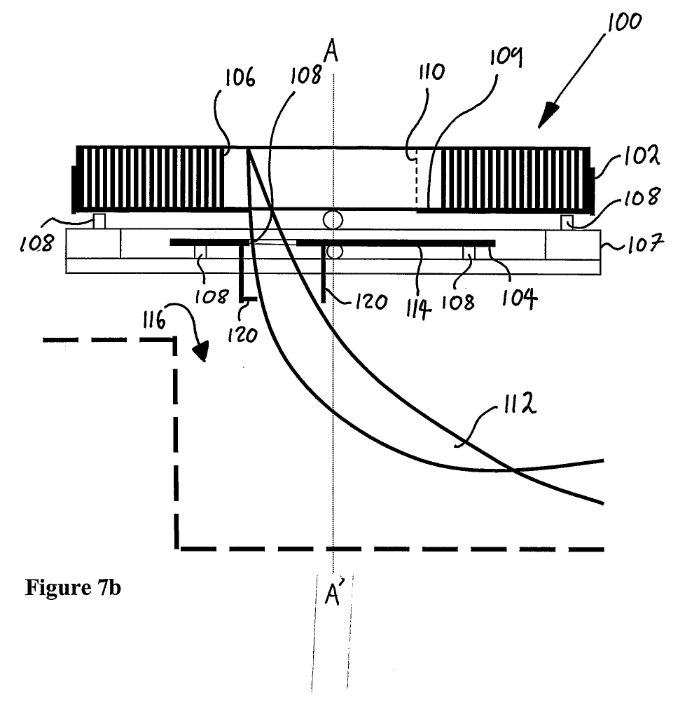

FIG. 7a shows a simplified plan cross-section of a first strip dispensing rig;

FIG. 7b shows a simplified side cross-section of the first strip dispensing rig of FIG. 7a, in operation, providing a helically twisted strip;

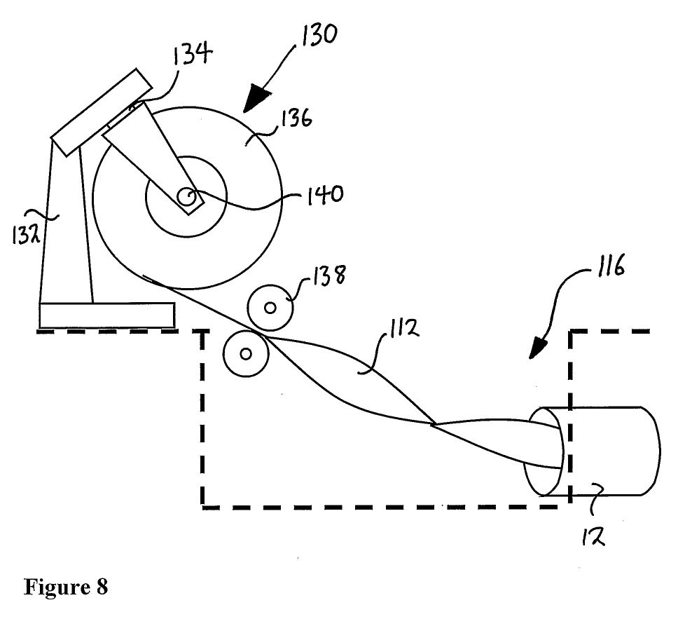

FIG. 8 shows a second strip dispensing rig in operation, providing a helically twisted strip;

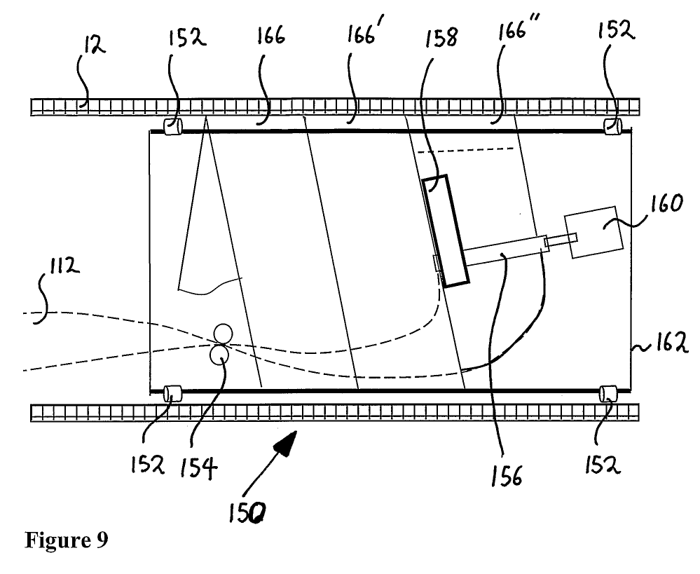

FIG. 9 shows a helical lining rig of a first configuration, in operation, installing a layer of the composite lining in a helical lining arrangement;

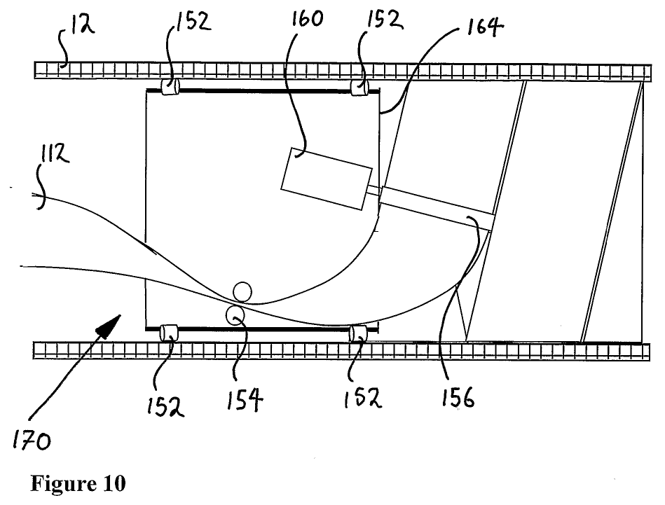

FIG. 10 shows a helical lining rig of a second configuration, in operation, installing a layer of the composite lining in a helical lining arrangement;

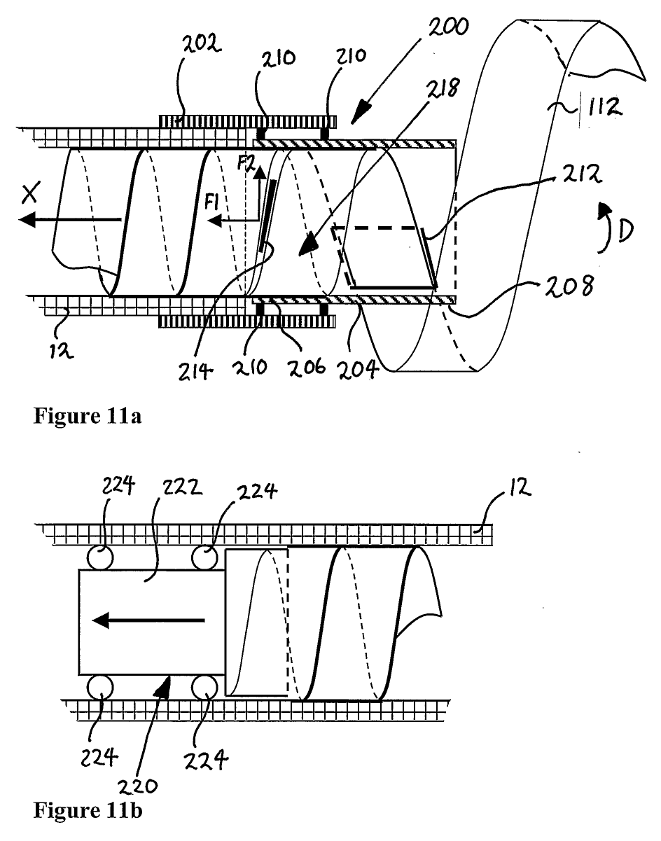

FIG. 11a and 11b shows a helical lining rig of a third configuration, in operation, installing a layer of the composite lining in a helical lining arrangement;

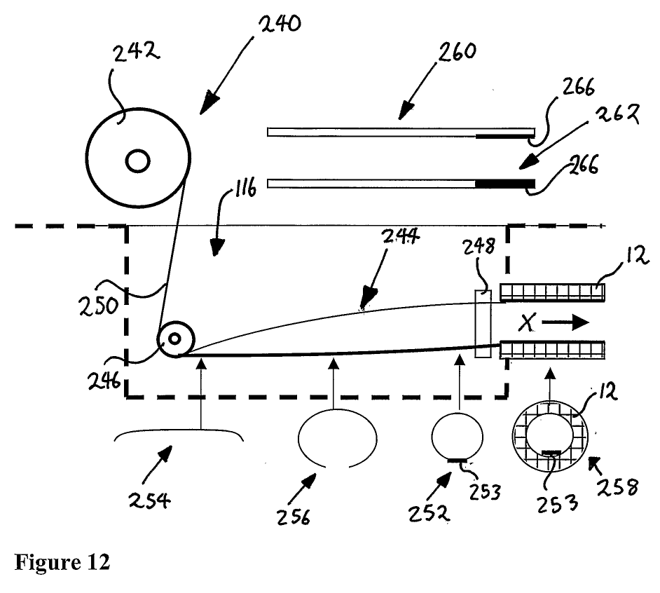

FIG. 12 shows a containment layer installation rig of a first configuration, in operation, providing a containment layer for a composite lining in a tubular arrangement, for drawing into a pipe;

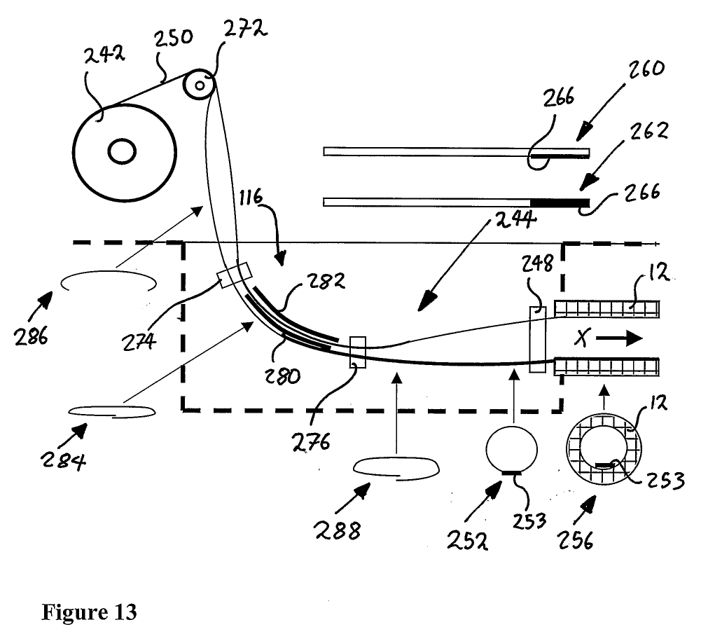

FIG. 13 shows a containment layer installation rig of a second configuration, in operation, providing a containment layer for a composite lining in a tubular arrangement, for drawing into a pipe;

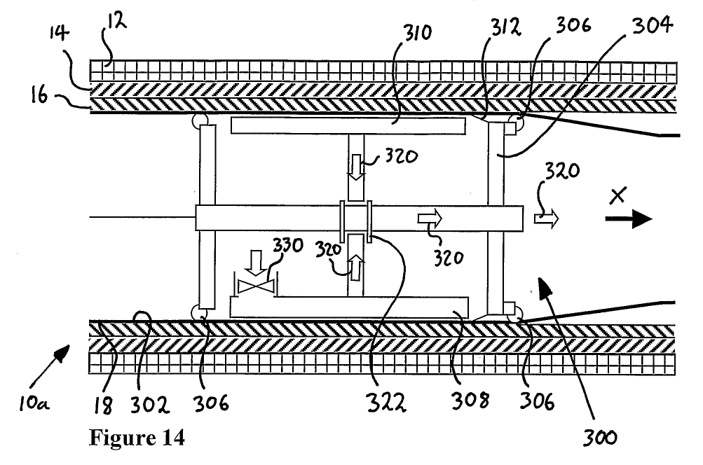

FIG. 14 shows a travelling welding rig, in operation.

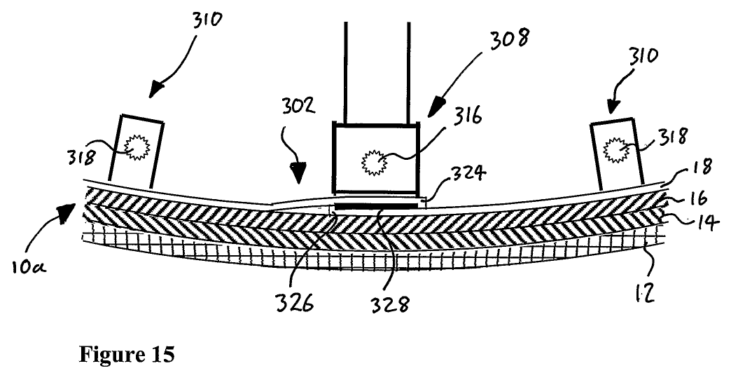

FIG. 15 shows a first partial cross-section of the travelling welding rig, in operation, welding a seam of a tubular lining;

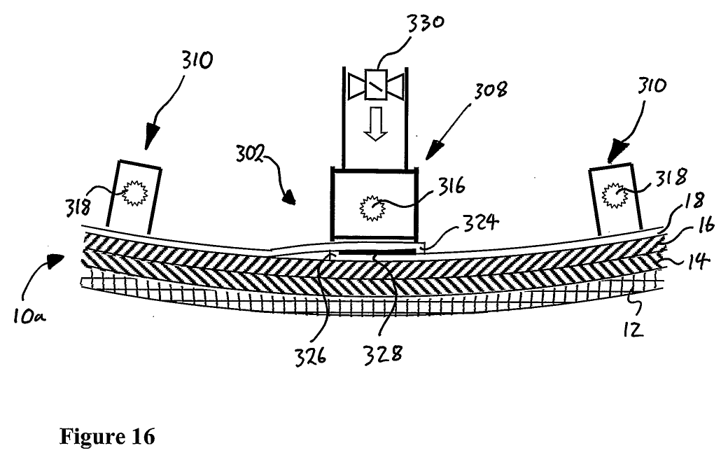

FIG. 16 shows a second partial cross-section of the travelling welding rig, in operation, welding a seam of a tubular lining;

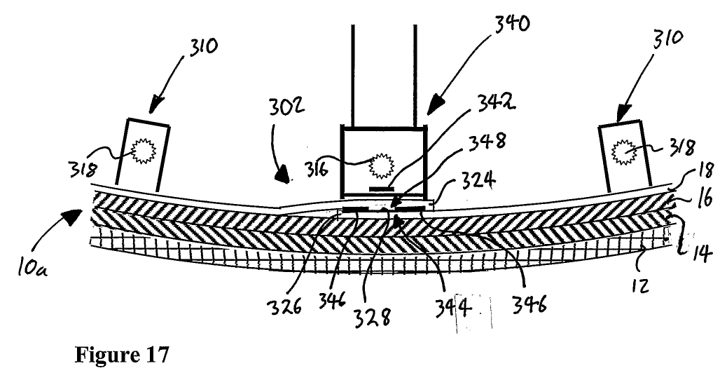

FIG. 17 shows a partial cross-section illustrating an alternative seam welding arrangement for the travelling welding rig, in operation, welding a seam of a tubular lining to produce a double weld;

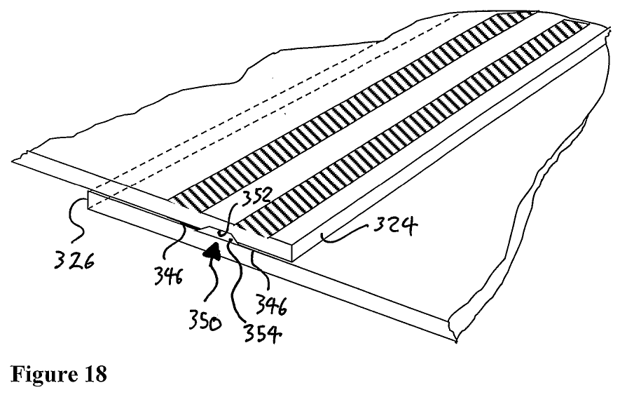

FIG. 18 shows a cutaway three-dimensional view of a double welded seam produced by the seam welding arrangement of FIG. 17.

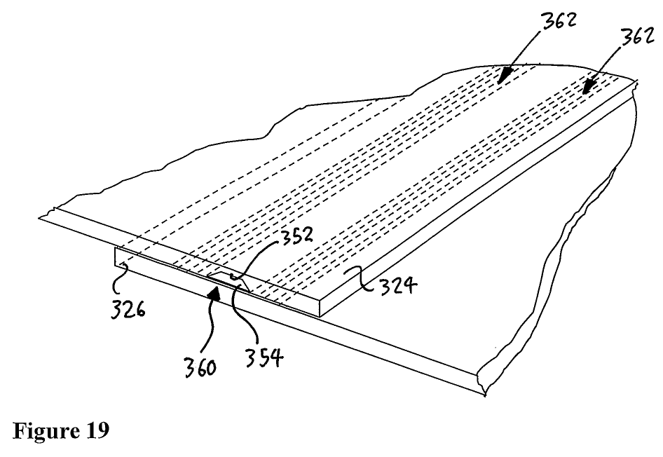

FIG. 19 shows a cutaway three-dimensional view of a double welded seam produced by electrofusion welding;

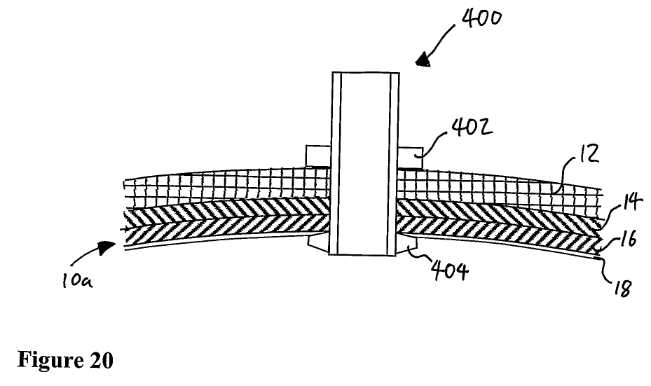

FIG. 20 shows a service connection for a pipe lined with a composite lining;

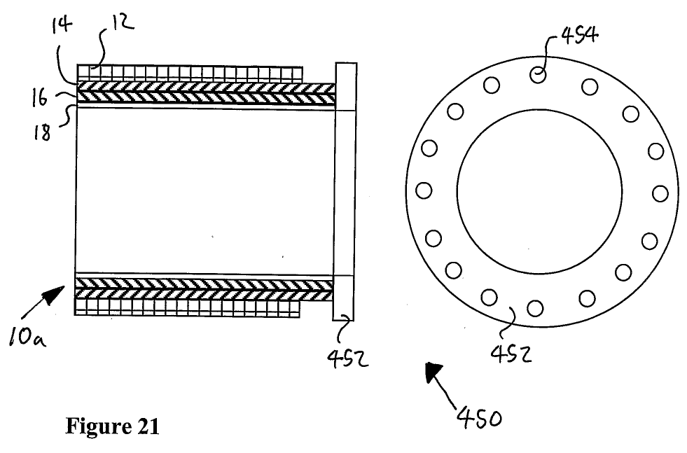

FIG. 21 shows an end connection arrangement for a pipe lined with a composite lining.

In FIGS. 1 & 2 a first embodiment of a composite lining is shown generally at 10a. In operation, the composite lining 10a is provided within a host pipe 12. The lining 10a comprises an outer and an inner structural layer 14, 16, for providing structural integrity, and a containment layer 18 for providing fluid impermeability.

Each structural layer 14, 16, comprises a lining strip helically wound tightly, with each turn lying in substantial contact with each adjacent turn. Thus, each strip forms a substantially continuous, cylindrical and tubular structure. The lining strip of the outer structural layer 14 is wound in a first helical direction onto an inner surface of the host pipe 12. Similarly, the lining strip of the inner structural layer 16 is wound in an opposite helical direction onto an inner surface of the outer structural layer 14.

Each lining strip 14, 16 is of a suitable thickness such, that when wound, it forms a generally rigid structure of a structural strength appropriate to the lining application. Similarly, each lining strip 14, 16 is of a width suitable for winding into a generally cylindrical structure of diameter suitable for lining the pipe 12. Typically for a 600 mm diameter pipe, for example, each lining strip is approximately 15 mm thick, and has a width approximately equal to the radius of the pipe being lined.

The lining strips may be made of any suitable flexible material, for example, a thermoplastic material such as polyethylene or the like. Suitable thermoplastic material is commonly available, at relatively low cost, in the form of extruded sheet supplied on a roll or coil. Typically, the material is available in widths of up to 9 m and thickness of up to 100 mm.

Hence, the helically wound structural layers form a stable structural assembly held in place by the host pipe 12. However, the structure formed by the structural layers 14, 16, alone is not fluid impermeable, since fluids such as gas or water can leak via the edges of the lining strips 14, 16. Hence, the containment layer 18 is provided to afford the required fluid containment properties.

The containment layer 18, comprises a generally rectangular and elongated sheet of a thin fluid impermeable material, arranged to form a substantially cylindrical tube within the inner structural layer 16 and hence resist internal pressure within the pipe. Longitudinal edges of the lining sheet overlap and are bonded to form at least one fluid impermeable seam along the length of the tube. The containment tube 18 is normally at least partially bonded to the inner surface of the inner structural layer 16.

The impermeable material may comprise any suitable material of any suitable thickness. Typically, for example, the material will be a thermoplastic material such as polyethylene or the like of a thickness in the region of 4 mm.

The tube may be seamed and bonded to the structural layer using any suitable bonding technique. For example, suitable bonding techniques for thermoplastic materials include the use of infrared radiation, ultrasound, or electro fusion.

Hence, the composite lining of the first embodiment comprises a fluid impermeable lining having structural strength sufficient for use as either: a semi-structural lining that reinforces the host pipe to provide a structural combination equivalent to a standard pipe; or a fully structural lining that can match the pressure specification of standard pipes of similar wall thickness, without the aid of the host pipe. Typically, for example, a pipe lining with a 17.6 SDR (standard dimensional ratio) would be 600 mm in diameter, and have a 34 mm wall thickness made up of two 15 mm thick structural layers, and a containment layer of 4 mm thick.

In FIG. 3 a second embodiment of a composite lining is shown generally at 10b, within a host pipe 12. The composite lining 10a of the second embodiment is similar to that of the first embodiment and like parts are given like reference numerals. However, the composite lining 10a comprises only a single structural layer 14 and a containment layer 18.

The structural layer 14 comprises a lining strip helically wound to form a generally cylindrical and tubular structure around an internal surface of the host pipe 12, generally as described for the first embodiment. The containment layer 18, comprises a thin sheet of fluid impermeable material, arranged to form a substantially cylindrical tube, longitudinally seamed for fluid impermeability as generally described for the first embodiment. In the absence of two structural layers, however, the containment tube 18 is normally at least partially bonded to the inner surface of the single structural layer 14.

Thus the second embodiment provides a semi-structural configuration that is nevertheless gas and liquid tight with respect to internal pressure and has sufficient structural rigidity to support itself within a pipe.

In FIG. 4, a third embodiment of a composite lining is shown generally at 10c, within a host pipe 12. The composite lining 10c of the fourth embodiment is similar to that of the third embodiments and like parts are given like reference numerals. Like the third embodiment the composite lining 10a comprises only a single structural layer 14 and a containment layer 20. The containment layer 20, however, is provided around the outer surface of the structural layer 14.

The structural layer 14 comprises a lining strip helically wound to form a generally cylindrical and tubular structure around an internal surface of the containment layer 20. The containment layer 20 comprises a thin sheet of fluid impermeable material, arranged to form a substantially cylindrical tube, longitudinally seamed for fluid impermeability.

Thus, the composite liner 10c is liquid tight and has sufficient structural rigidity to support itself within a pipe and to resist external pressure due to water or gas ingress. The structural layer internally supports the sheet layer and presses it firmly onto the pipe wall thereby forcing the overlapping seam surfaces together. This is particularly beneficial for lining applications where water or water ingress is present and hence normal welding methods may not be possible. In such cases the seam can be made water tight by using a flexible adhesive or mastic previously applied during installation along a contact area of the seam.

It will be appreciated that the composite lining 10c is also particularly useful in applications such as gravity sewers, and the like, where external ground loading and external water pressure are key forces.

In FIG. 5, a fourth embodiment of a composite lining is shown generally at 10d, within a host pipe 12. The composite lining 10d of the fourth embodiment is similar to that of earlier embodiments and like parts are given like reference numerals.

The composite lining 10d comprises helically wound outer and inner structural layers 14, 16, for providing structural integrity, and a tubular containment layer 18 for providing fluid impermeability, generally as described for the first embodiment. Unlike the first embodiment, however, the composite lining 10d is further provided with an outer containment layer 20, located between the outer structural layer 14 and the host pipe 12.

The outer containment layer 20 comprises a thin sheet of fluid impermeable material, arranged to form a substantially cylindrical tube, longitudinally seamed for fluid impermeability, as generally described for the containment layer 18 of the first embodiment.

Thus, the inner and outer containment layers 18, 20 provide a means of resisting both internal and external pressure. In addition, the inner and outer containment layers 18, 20 define an enclosed region of annular cross-section through which fluids can potentially flow, in operation, via the contact areas between adjacent turns of the helical structural layers 14, 16, and also via the permeable contact region between the two layers 14, 16. However, fluids will only enter the enclosed region if, in operation, there is a leak in the inner or outer containment layers 18, 20.

The enclosed region described above represents means by which leakage may be detected. Hence, the fourth embodiment provides a composite lining 10d having leakage monitoring means, for detecting gas or liquid leakage through the inner containment layer 18, by monitoring the pressure or flow of fluid in the space between the inner and outer seamed tube linings.

In FIG. 6, a fifth embodiment of a composite lining is shown generally at 10e, within a host pipe 12. The composite lining 10e of the fifth embodiment is similar to that of earlier embodiments and like parts are given like reference numerals.

The composite lining 10e comprises helically wound inner and outer structural layers 16, 14, and inner and outer tubular containment layers 18, 20 generally as described for the fourth embodiment. Unlike the fourth embodiment, however, the composite lining 10e is further provided with an intermediate containment layer 22, located between the inner and outer structural layers 16, 14.

The intermediate containment layer 22 comprises a thin sheet of fluid impermeable material, arranged to form a substantially cylindrical tube, longitudinally seamed for fluid impermeability, as generally described for the containment layers 18, 20 of previous embodiments.

The fifth embodiment is particularly advantageous for providing smooth internal surfaces to enable gas and water tight welding in applications where the host pipe 12 includes severe deformities.

It can be seen therefore that the component layers of the composite liner can be assembled into various configurations to meet particular pipe lining specifications. The first embodiment, for example, comprises a preferred structural configuration having two oppositely wound helical structural layers with a single inner containment layer. Conversely, semi-structural linings, such as that of the second embodiment, may only require one structural and one containment layer. The extra containment layers of the fourth and fifth embodiments provide the means for resisting external liquid ingress, and means of leak detection. Furthermore, the three containment layers and two helical layers of the fifth embodiment assist in providing a smooth lining inside a host pipe having severe deformities. It will be appreciated that other configurations are possible to meet particular design or material requirements. For example, pipes may be lined with more than three structural layers, and any suitable number of containment layers, in any suitable position. Furthermore, a plurality of thin layers may be used instead of one or more thicker layers, depending on the application.

Installation of structural layers of a composite lining according to any one of the embodiments will now be described by way of example only with reference to FIGS. 7a to 10.

In FIGS. 7a and 7b, a first strip dispensing rig for dispensing a twisted lining strip into a pipe is shown in operation, generally at 100. The rig 100 comprises first and second coaxially aligned turntables 102, 104. In operation, a coil 106 of structural lining material is mounted coaxially on the first turntable 102 for subsequent dispensing into the pipe.

As best seen in FIG. 7a, the coil 106 comprises a spirally wound strip of lining material of suitable width and thickness for forming the helical structural layers 14, 16, of the composite lining 10a, 10b, 10c, 10d, or 10e. It will be appreciated that the spiral of FIG. 7a is shown illustratively and that the concentric circles shown are intended to represent the consecutive spiral turns of the coil.

Each turntable 102, 104, is rotatable independent of the other, relative to a substantially fixed base 107, on an associated set of wheels 108 about a rotation axis AA′. The turntables 102, 104 are freely rotatable, but may be powered in applications where the coil 106 is particularly large.

The first turntable 102 comprises a coil support platform 109, which is rotatable with the turntable, and includes a substantially circular aperture 110, axially aligned with the axis AA′, through which a helically twisted strip of lining material 112 may be dispensed, in operation, from a centermost turn of the spiral coil 106.

The second turntable 104 comprises a platform 114, which is rotatable with the turntable. The platform 114 includes a sectored control aperture 118 through which the strip 112 is dispensed, in operation, from the coil 106, into an access pit 116 as the strip 112 is drawn into the pipe. The second turntable 104 is further provided with guide rods 120, located on an underside of the sectored aperture 118. The guide rods 120 are arranged for guiding and controlling the strip 112 as it enters the access pit 116.

In operation, the strip is drawn into an exposed pipe end located in the access pit 116 by a helical winding rig, as described with reference to any one of FIGS. 9 to 11, as the winding rig lines the pipe with a helical structural layer.

It will be appreciated that the strip 112 being drawn into the pipe needs to be loosely wound into an elongated helix to allow practical formation of the structural layer. In operation, one twist of the loosely wound helical strip 112 is generally required for every turn of the helical structural layer being wound.

In operation as the strip 112 is drawn into the pipe the second turntable 104 rotates as the strip is dispensed from the coil 106, in dependence on the demand for helical turns. Thus, the rotation of the second turntable 104 guides and controls the strip 112, as it is drawn from the coil, through both the sectored control aperture 118, and the circular aperture 110. In the absence of any rotation of the first turntable 102, the coil 106 naturally provides helical twists in dependence on the inside diameter of the coil 106 at the time the twist is formed.

In practice, however, the natural twist provided by the coil 106 will be insufficient to meet the demands of the application. This is particularly relevant, for example, during formation of a structural lining in a smaller diameter pipe. Where more twists are required, the first turntable 102, and hence the coil 106 is rotated in a rotational direction ‘C’, corresponding to the directional wind of the spiral, from inside to outside. The speed of rotation is controlled to provide the required frequency of helical twists.

It will be appreciated that appropriate rotation of the coil 106 in an opposite direction to ‘C’ will result in a lower helical twist frequency. It will be further appreciated that the dispensing rig 100 may also be used to unwind a structural layer from within the pipe, back into the coil.

In the event that the lining strip material on the coil 106 is exhausted, a new coil (not shown) is installed and a new strip (not shown) butt-fusion welded to a tail end of the previous lining strip using conventional techniques. The space around the longitudinal central axis of the helix may be used to conveniently accommodate cables for electricity, data, or the like.

Hence, in operation, relatively small access pits 116 are dug to provide access to either end of a section of the pipe requiring lining. The pipe is then opened at both ends of the section and the lining strip 112 is fitted into a helical winding rig (as seen in and described for FIG. 9, 10, or 11 below), provided at one end of the pipe, where it is held until the rig is ready to line the pipe. Where the rig is located at a far end of the pipe (as described with reference to FIG. 10) the strip is drawn into the pipe by a winch (not shown). During installation of each structural layer, the helical winding the rig draws additional twisted strip 112 from the coil 106 to form the lining strip into a cylindrical tubular structure. The demand for helical turns is met by controlled rotation of the first turntable 102.

In FIG. 8 an installation rig for dispensing a twisted lining strip into a pipeline is shown in operation, generally at 130. The rig 130 comprises a supporting stand 132 having a coil bearing 134 by which a coil 136 and a set of guide rollers 138 are rotatably mounted to the stand 132.

The coil 136 comprises a spirally wound strip of lining material for forming the helical structural layers 14, 16, of the composite lining 10a, 10b, 10c, 10d, 10e. The coil 136 is rotatable about a central axis 140 for dispensing the lining material evenly through the guide rollers 138. The coil 136 and the guide rollers 138 are further rotatable on the bearing 134 about an axis generally perpendicular to the central axis 140 of the coil 136, to twist the dispensed lining material into a loosely formed helix 112 as it is drawn into a pipe 12, during operation.

Hence, in operation, relatively small access pits 116 are dug to provide access to either end of a section of the pipe requiring lining. The pipe is then opened at both ends of the section and the lining strip 112 is fitted into a helical winding rig (as seen in and described for FIG. 9, 10, or 11 below), provided at one end of the pipe, where it is held until the rig is ready to line the pipe. Where the rig is located at a far end of the pipe (as described with reference to FIG. 10) the strip is drawn into the pipe by a winch (not shown).

As the lining material is pulled from the coil 136 through the rollers 138, the coil 136 and rollers 138 are twisted about the rotational axis 134 of the bearing to twist the lining material into the loosely formed helix 112, which is then drawn into the pipe 12. During the installation of each structural layer, the helical winding the rig draws additional twisted strip from the coil 136 to form the lining strip into a cylindrical tubular structure. Effectively, one twist of the lining strip is used for every helical turn carried out by the winding rig.

In the event that the lining strip on the coil 136 is exhausted, a new coil (not shown) is installed and a new strip (not shown) butt-fusion welded to a tail end of the previous lining strip using conventional techniques. The space around the longitudinal central axis of the helix may be used to conveniently accommodate cables for electricity, data, or the like.

In FIG. 9 a helical winding rig of a first configuration is shown at 150. The winding rig 150 is shown in operation, helically lining a pipe 12, with a lining strip 112 dispensed from an installation rig as described with reference to FIGS. 7a and 7b, or 8, to produce a structural layer 14. The winding rig 150 comprises a plurality of guide wheels 152, an optional set of powered guide rollers 154, a set of powered pinch rollers 156, and an edge guide 158.

In operation, however, the winding rig 150 is initially located at a near end of the pipe 12 relative to the rig dispensing the loose helical strip 112. The loose helical strip 112 is passed through each set of rollers 154, 156 to configure the winding rig 150 for lining the pipe 12 with the helical structural layer 14.

The guide wheels 152 are mounted at the outer limits of the winding rig 150 to allow the rig to rotate freely within the pipe 12, about its axial centre, whilst moving longitudinally long the pipe 12.

Where fitted, the powered guide rollers 154 are located in the winding rig 150, and are arranged to draw the loosely twisted helical strip 112 dispensed from the installation rig into the winding rig 150.

The pinch rollers 156 are powered by suitable means 160 for feeding the strip 112 onto the internal surface of the pipe 12, or previously installed lining layer, in a tightly formed helix. The pinch rollers 156 extend from near a front end 162 of the rig 150, relative to its operational direction of travel, towards a tail end 164, at a predetermined angle relative to a plane perpendicular to the central axis of the pipe 12. The predetermined angle is chosen for producing helical turns 166 having a desired helical slope, generally near perpendicular to the longitudinal axis of the pinch rollers 156.

The edge guide 158 is curved, being shaped for general conformity with the inner surface of the pipe 12. The guide 158 is biased against the inner surface of the pipe, or previously laid layer of the composite lining, by any suitable means, such as a resilient spring or the like. The guide 158 is fitted to the rig 150, in a position for, in operation, general alignment adjacent to an edge of the most recently completed helical turn 166′, just ahead of the point at which the strip 112 contacts the inner surface during formation the subsequent turn 166″. At least part of the guide 158 is in contact with the edge of the most recently completed turn 166′. Thus, in operation the guide 158 forces the spiral winding rig to move along the pipe as it follows the edge of the previously completed turn 166′.

It will be appreciated that the position of the guide 158 may be slightly misaligned relative to the edge of the most recently completed turn 166′, as seen in FIG. 9, such that the guide 158 forms a narrow gap between the turn 166″ currently being formed and the previous turn 166′. Such a gap ensures that the spiral turns do not overlap during the winding action. The gap is automatically closed, in operation, after the subsequent turn 166″ is completed under a force applied to its edge by the guide 158.

It will be appreciated that whilst the guide 158 described is advantageous, alternative or additional guide mechanisms may be used for translating the loosely twisted helical strip 112 into the tight helical feed required to line the pipe.

Hence, in operation, the opposing reaction force on the pinch rollers 156, and the guide 158, produced by the helical winding action, forces the freely rotating rig 150, both to rotate about the central axis of the pipe 12, and to travel longitudinally along the pipe 12, until the helical lining process is complete. Thus, the direction of travel is towards a far end of the pipe relative to the installation rig, the helical strip being trailed behind the winding rig 150, inside the newly wound structural layer 14.

In FIG. 10 a helical winding rig of a second configuration is shown at 170. The winding rig 170 is shown in operation, helically lining a pipe 12, with a lining strip 112 dispensed from an installation rig as described with reference to FIGS. 7a and 7b, or 8, to produce the structural layer 14. The winding rig 170 comprises a plurality of guide wheels 152, an optional set of powered guide rollers 154, and a set of pinch rollers 156 generally as described for the first configuration 150 and like parts are given like reference numerals.

However, in operation, the winding rig 170 is initially located at a far end of the pipe 12 relative to the rig dispensing the loose helical strip 112. Like the first configuration 150 the loose helical strip 112 is passed through the optional set of powered guide rollers 154 and the powered pinch rollers 156, to configure the winding rig 170 for lining the pipe 12 with the helical structural layer 14.

Where fitted, the powered guide rollers 154 are arranged to draw the loosely twisted helical strip 112 dispensed from the installation rig into the pipe 12, as the strip 112 is required by the winding rig 170.

The pinch rollers 156 are powered by suitable means 160 for feeding the strip 112 onto the internal surface of the pipe 12, or previously installed lining layer, in a tightly formed helix. Like the first configuration, the pinch rollers 156 are positioned at a predetermined angle for producing helical turns having a desired helical slope, as generally described previously. Unlike the previous configuration, however, the pinch rollers 156 extend outwardly from a rear end 164 of the rig 170 relative to its operational direction of travel.

Suitable guides (not shown) are provided for translating the loosely twisted helical strip 112 into the tight helical feed required to line the pipe.

Hence, in operation, the opposing reaction force on the pinch rollers 156 produced by the helical winding action, forces the freely rotating rig 170, both to rotate about the central axis of the pipe 12, and to travel longitudinally along the pipe 12, ahead of the most recently wound turn, until the helical lining process is complete. Thus, the direction of travel is towards a near end of the pipe relative to the rig dispensing the loose helical strip 112, the loosely wound helical strip 112 being trailed in front of the winding rig 170.

With reference to FIGS. 9 and 10, in operation, the lining process using either configuration requires careful control of the longitudinal travel, by means of the strip tension and the feed direction of the pinch rollers 156. It will be appreciated that mechanical and electrical sensing of the edge of the previous spiral turn may be used to provide the means for such control.

It will be further appreciated that a helical winding rig of either configuration has the advantage that it can be stopped at any time, for say inspection, and reversed to unwind the helically wound strip if required.

In FIG. 11a, a helical winding rig of a third configuration is shown at 200, in operation winding a first structural layer 14. The winding rig 200 is shown lining a pipe 12, with a lining strip 112 dispensed from an installation rig as described with reference to either FIGS. 7a and 7b or 8, to produce the structural layer 14. The winding rig 200 comprises an outer cylinder 202 and an inner cylinder 204.

The outer cylinder 202 is tubular having an inner radius substantially equal or slightly greater than the external radius of the pipe 12. In operation, the outer cylinder 202 is clamped or otherwise fixed coaxially to an exposed end of the pipe 12, by any suitable means.

The inner cylinder 204 is tubular having an inner radius substantially equal to the internal radius of the pipe 12. A first end 206 of the inner cylinder 204 is located coaxially within the outer cylinder 202, in operation, generally adjacent the exposed end of the pipe. A second end 208 of the inner cylinder 204 extends outwardly from the outer cylinder 202. The inner cylinder 204 is rotatable within the outer cylinder 202 on suitable wheels or bearings 210.

A strip insertion slot 212 is provided in the wall of the second end 208 of the inner cylinder 204 through which a lining strip 112 may be introduced during operation. A helical guide 214 is provided within the inner cylinder 204 on an inside surface for guiding lining strip inserted through the slot 212. The slot 212 is of suitable size and shape to allow the strip 112 to be inserted through the slot 212 for forming turns of the desired helical angle against the inside surface of the inner cylinder 204.

The helical guide 214 comprises an internal ridge or the like extending helically around at least a portion of the inner surface, at a helical angle generally similar to the helical angle required for each turn of the structural layer 14 being formed. It will be appreciated that although the helical guide is shown extending around only a portion of the inner surface, the guide 214 may alternatively be of any suitable length, for example, in the manner of a screw thread extending fully around the inside circumference of the inner cylinder in one or more helical turns. It will be further appreciated that the guide 214 may have a retaining shape for helping to retain the strip 112 generally against the inside surface of the inner cylinder 204, in operation.

The strip 112 comprises a loosely wound open helix having a tapered lead end. In operation, the loosely wound helical strip 112 is initially dispensed from the strip dispensing rig, and fed through the insertion slot 212 to form a tighter helical region 218 on the inside surface of the inner cylinder 204. The helical region 218 is slightly open, and is wound such that adjacent edges of at least two subsequent turns are located on either side of the helical guide 214. It will be appreciated that the tighter helical region 218 may extend partially into the end of the host pipe 12.

Once the tighter helical region 218 has been formed the inner cylinder 204 is rotated in rotational direction ‘D’, on the guide wheels or bearings 210, by a motorized drive or the like (not shown). As the inner cylinder 204 rotates, the helical guide 214 engages between subsequent turns of the tighter region 218, and induces an axial force component F1 in a direction ‘X’ axially down the pipe 12, and a smaller transverse or turning force F2 orthogonal to F1, on the helical region 218. The axial component F1 acts to drive the helical region 218 down the pipe 12 and smaller turning force acts to rotate the region 218 in direction ‘D’. Hence, the helically wound strip begins to move along the pipe 12.

As the inner cylinder 204 rotates, the stiffness of the wound helical strip forces the lining tube into pressure contact with an inside surface of the host pipe 12, thus generating frictional forces, which act against axial force F1. However, as the frictional force builds up the rotating force F2 causes the helical region 218 to tighten, thus reducing the diameter of the region 218. Hence, the frictional forces are also reduced allowing axial travel in the direction ‘X’ to continue. In operation, the build up of frictional forces is therefore self-regulatory and hence the lining action produced results is relatively rapid travel of the structural lining strip along the pipe 12 with only a relatively small amount of rotation.

As the strip 112 travels into and along the pipe 12 the axial force F1 forces subsequent turns together, thus forming the substantially continuous tubular structural layer 14 as described earlier. Maximum lining lengths are greater when the strip is thicker and stiffer and the friction between the lining surfaces is least, for example, in the presence of water.

The helical lining action produced by the rig 200, described with reference to FIG. 11a, may be enhanced by the provision of a pig 220 as illustrated in FIG. 11b. The pig 220 comprises a body 222 provided with axially aligned guide wheels 224 biased into pressure contact with the inner surface of the host pipe 12. The wheels 224 are provided with a tread of suitable design and material to grip the inner surface of the pipe 12, thereby resisting rotation of the pig 220 whilst allowing free axial travel.

In operation, the pig 220 is inserted into the host pipe 12 before lining commences, the tapered end of the loosely wound helical strip 112 dispensed from the strip dispensing rig, and fed through the insertion slot 212 to form the tighter helical region 218, is connected to the body 222 of the pig 220.

Thus, in operation to line the pipe 12, the pig 220 resists rotation induced by the turning force F2 whilst assisting axial travel in the direction ‘X’ under the influence of the axial force F1. Hence, as the inner cylinder 204 is rotated under the turning force F2, the diameter of the full length of the helically wound structural layer 14, and the associated frictional force is reduced between the pig 220 and the rig 200. The tubular structural layer 14 is therefore allowed to travel along the host pipe with a minimum of opposing frictional forces. This allows greater maximum lining lengths and improves the efficiency of the lining action. This installation configuration is particularly suitable for small pipes where mobile helical winding rigs are too small to be practical.

It will be appreciated that although the equipment of FIGS. 7a to 11 is shown for producing an outermost helical structural layer wound in a particular helical direction, the equipment is easily reversible for producing a helical structural layer wound in an opposite helical direction. Furthermore, the winding rig may be used for winding further structural layers, within the outermost layer, to produce composite linings having a plurality of such layers wound in either direction.

Installation of a containment layer of a composite lining, according to any one of the embodiments will now be described by way of example only with reference to FIGS. 12 to 18.

In order to install the containment layer it is necessary to provide a sheet of suitable material of sufficient width to be formed into a cylindrical tube of diameter substantially equal to the internal diameter of either a host pipe 12, or a previously installed layer of the composite lining, with overlapping longitudinal edges. The sheet then needs to be formed into the generally cylindrical tubular structure for drawing into the pipe 12, before it is impermeably seamed along the overlapping edge and bonded to a structural layer, if required.

In FIG. 12 a first containment layer installation arrangement is shown generally at 240, in operation, providing a containment layer of a composite lining and forming it into a tubular arrangement, for drawing into a pipe 12.

The installation arrangement 240 comprises a roll of containment lining material 242 mounted externally to a relatively small access pit 116, and a forming section 244. The width of the roll is sufficient for the lining material to cover the internal circumference of the host pipe 12 with some overlap as previously described with reference to the containment layer.

The forming section 244 comprises a roller portion 246, located generally at an opposite end of the access pit 116 to the exposed end of the pipe 12. The roller portion 246 is generally aligned with the exposed end, but has an axis of rotation generally perpendicular the longitudinal axis of the pipe 12.

The forming section 244 further comprises a rounding die 248, generally adjacent the exposed end of the pipe 12, configured to form a sheet of lining material 250 drawn from the roll 242, in operation, into a lining portion having an overlapping tubular cross section 252. The overlap of the tubular cross-section 252 forms a seam 253, which in operation is seam welded after the lining tube is in place in the pipe 12.

In operation, the sheet of lining material 250 is initially fed from the roll 242, into the access pit 116, around the roller 246, through the die 248 and into the pipe 12. The sheet 250 is thus initially flat as it leaves the roll 242 and passes over the roller. The sheet 250 then begins its transition to having the tubular cross-section 252 via intermediate cross-sectional stages 254 and 256. A winch (not shown) at a far end of the pipe 12 draws the tubularly formed lining sheet into the pipe 12 in the direction ‘X’, to form a lined cross-section 258. Hence, the tube is free from kinking that might cause distortion in the lining of the pipe 12.

In order to allow the overlapping longitudinal seam of containment layer to be welded using infrared bonding, the bulk of the containment layer material is coloured to allow infrared transmission through the sheet. As seen in the inserts 260 and 262, a longitudinal edge region of the containment layer sheet comprises an absorption surface 266, coloured for allowing infrared absorption.

The inserts 260, 262 show two possible alternative ways in which the absorption surface 266 may be implemented. In the example of insert 260, the absorption surface 266 forms part of a region extending only partially through the thickness of the edge region. Contrastingly, in the example of insert 262, the absorption surface 266 forms part of a continuous region extending through the full thickness of the sheet, such that both the upper and lower surfaces are infrared absorptive.

In operation, the containment layer is arranged in a tubular form such that the absorption surface 266 of the corresponding longitudinal edge region is overlapped, inside the tube, by a region of infrared transparent material, to form the overlapping seam. Hence, infrared radiation applied to the seam, from within the pipe 12, passes through the infrared transparent region to heat the absorption surface 266 and thus weld the two overlapping edges together.

Furthermore, in order to allow the containment layer to be welded to a helical structural layer, the structural layers of the composite lining are also coloured to allow infrared absorption. The absorption surface and structural layers may be any suitable absorptive colour. Typically, for example, the structural layers are made from black polyethylene and the sheet tube layer made from a natural coloured polyethylene with an opaque black region for the absorption surface 266.

Normally, the seam is provided at the bottom of the pipe 12, as shown in the cross-sections 258, to avoid service connections and the like, which are normally made to the top of the pipe 12. It will be appreciated, however, but the installation arrangement 240 is configurable to provide a containment layer having a seam at the top of the pipe 12, by feeding the sheet through the rig with the sheet edges at the top.

It will be appreciated that a further advantage of infrared welding as described above is the distinctive change of colour, which occurs at the weld interface, because of the surface wetting effect of the molten plastic. The colour change can be used to provide means of verifying that the weld and lining process is complete.

Typically, the size of the access pit required to accommodate the dispensing rig is approximately three times the sheet width in width and approximately ten times the nominal pipe diameter in length. For a larger diameter pipe, however, the containment material may be too wide for a practically sized access pit. A typical width of lining material, for example, is 3.5 m for a pipe of 1 m diameter. Hence, the sheet width requires reducing before entry into the access pit. In order to do this in operation, the sheet has to be folded to reduce its width, before being curved into the access pit for alignment with an exposed end of the pipe. This operation has to be completed without undesirable deformation such as kinking or the like.

In FIG. 13 a second containment layer installation arrangement is shown generally at 270, in operation, providing a containment layer of a composite lining and forming it into a tubular arrangement, for drawing into a pipe 12. The second arrangement 270 is similar to the first arrangement 240, and like parts are given like reference numerals.

The installation arrangement 270 comprises a roll of containment lining material 242 mounted externally to a relatively small access pit 116, and a forming section 244. The width of the roll is sufficient for the lining material to cover the internal circumference of the host pipe with some overlap as previously described with reference to the containment layer.

The forming rig 244 comprises a guide roller 272, first and second formation die 274, 276, a rounding die 248, a profiling tongue 280, and a low friction guide 282.

The guide roller 272 is generally similar the roller portion 246 of the first arrangement 240. Unlike the roller portion 246, the guide roller of the second arrangement is located externally above the access pit 116 in a position suitable for drawing a sheet of lining material 250 over the roller 272 into the access pit 116.

The first formation die 274 is located generally below the guide roller 272, just inside the access pit 116 and is configured for forming the substantially flat sheet 250 into a flattened tube as illustrated in cross-section at 284. The first die 274 is positioned at an angle relative to the vertical (as shown in FIG. 13), such that in operation the flattened tube of cross-section 284 formed by the die begins to curve from the vertical slightly towards the axial direction of the pipe 12.

The second formation die 276 is configured in substantially the same manner as the first, for the formation of a flattened tube of cross-section 284. The second formation die 276 is located in the access pit 116, between the first die 274 and the pipe 12 in a position aligned generally with an exposed end of the pipe 12. Hence, in operation, the second die 276 assists both to maintain the shape of the flattened tube 284 whilst it curves substantially from the vertical toward the axial direction of the pipe 12, and to align it generally with the pipe 12.

The alignment of the flattened tube 284 is further assisted, in operation, by the profiling tongue guide 280, and low friction guide 282. The tongue guide 280 and the guide 282 are both arranged arcuately, and are provided generally parallel one another, curving from a position generally adjacent and perpendicular to an output side of the first die 274, to a position generally adjacent and perpendicular to an input side of the second die 276.

It will be appreciated that the term input side refers to the side of each die 274, 276 into which the lining material is fed, in operation to line the pipe. Similarly, the term output side refers to the side of each die 274, 276 from which the lining material is drawn, in operation to line the pipe 12.

It will be further appreciated that although the tongue and low friction guides 280, 282 are each shown as a single arcuate guide one or both of the guides 280, 282 may comprise a series of discrete or semi-discrete guide portions arranged to form the desired curvature.

In operation, the flattened tube 284 is drawn over the tongue guide 280, locating the tongue guide 280 within the flattened tube 284. The tongue guide 280 is provided with a suitable support (not shown), which in operation passes through a gap formed by the flattened un-seamed edges of the tube 280, for holding the tongue guide 280 in place. Hence, the guides 280, 282 assist to direct the flattened tube 284 around the curve from the first to the second die 274, 276, thus helping to align the flattened tube 284 with the pipe 12.

The rounding die 248, is provided generally adjacent the exposed end of the pipe 12, and is configured to form the sheet of lining material 250 drawn from the roll 242 into a lining portion having an overlapping tubular cross section 252 as described with reference to FIG. 12. As described previously, the overlap of the tubular cross-section 252 forms a seam 253, which in operation is seam welded after the lining tube is in place in the pipe 12.

Hence, in operation the tube is initially fed over the guide roller 272 through the first die 274 to form the flat tubular cross-section 284. Thus, as the containment layer sheet 250 passes from the roller 272 to the first die 274 it forms an intermediate cross-section 286 before entering the access pit 116. Once the flattened cross-section 284 is formed by the first die 274 the lining material is curved towards the axial direction of the pipe 12 via the tongue 280 and the low-friction guide 282. The flattened tube 284 has a total width approximately half that of the original sheet width and hence can enter into a relatively small access pit 116.

When the flattened tube 284 is oriented correctly it passes through the second die 276 towards the rounding die 248. As seen in FIG. 13 the flattened tube expands as it is drawn from the second forming die 274, causing it to form an expanded cross-section 288 before finally achieving the substantially cylindrical cross-section 252 as it is drawn through the rounding die 248. A winch (not shown) at a far end of the pipe draws the tubularly formed lining sheet into the pipe 12 in the direction ‘X’, to form a lined cross-section 258. Hence, the tube is free from kinking that might cause distortion in the lining of the pipe.

As described with reference to FIG. 12, where infrared seam welding is required, the bulk of the containment layer material is coloured to allow infrared transmission through the sheet. A longitudinal edge region of the containment layer sheet comprises an absorption surface 266, coloured for allowing infrared absorption. The inserts 260, 262 show two possible alternative ways in which the absorption surface 266 may be implemented as described with reference to the first arrangement 240.

A preferred method for bonding and/or seam welding the component layers of the composite lining is the use of infrared radiation. The use of infrared radiation is particularly advantageous when using thermoplastic materials such as natural polyethylene, because when the material is in thin sheet form in its natural uncolored state, it is partially transparent to short wave infrared radiation. However, the materials may be made opaque to infrared when coloured appropriately, for example black, using dye, ink or embedded particles or fibres made from absorbing materials such as carbon. Thus, short wave infrared radiation, which avoids the peak absorption spectra of many thermoplastics, may be passed through an infrared transparent sheet in pressure contact with an underlying sheet, the contact region having opaque material at the interface. Hence, the opaque material is heated and consequently melted to weld the sheets together.

Additionally, infrared radiation warms up and softens infrared transparent thermoplastic material, because the material still absorbs some of the infrared energy. In operation, this is advantageous, because it can help a thermoplastic containment layer to conform to the shape of any deformities in an outer-lying structural layer and/or pipe, when appropriate pressure is applied.

In FIGS. 14 to 16 a welding rig is shown generally at 300. The rig 300 is shown in operation seam welding a seam 302 of a tubular containment layer 18, whilst substantially simultaneously welding the containment layer 18 to a structural lining 16 to form a composite lining 10.

The rig 300 will be described with reference to a composite lining 10a according to the first embodiment. It will be appreciated, however, that the welding rig 300 may be used in the construction of any similar lining, including composite linings 10b, 10c, 10d, 10e, according to the second, third, fourth, and fifth embodiments. Furthermore, the welding rig will be described with reference to infrared welding and associated features, it will be appreciated, however, that other forms of bonding are possible using a similar rig, for example, using ultrasound or electrofusion.

As best seen in FIG. 14, the welding rig 300 comprises an airtight shield portion 304, a set of radial wheels 306, a seam welding portion 308, and a plurality of sheet welding portions 310.

The shield portion 304 is provided at the front of the rig, relative to the direction of movement ‘X’ of the rig 300 from one end of the pipe 12 to another to weld the seam 302 of the containment layer 18 and to bond it to the structural layer 16. The shield portion 304, comprises at least one sliding seal 312 configured to provide an airtight seal between the shield 304 and the containment layer 18. It will be appreciated that any suitable number of seals may be used.

The radial wheels 306 are configured on the outer perimeter of the rig 300 to allow the rig to traverse the pipe 12 in a longitudinal direction. Hence, in operation air pressure applied behind the rig, relative to the direction of travel ‘X’, creates a pressurised region, which causes the rig 300 to move on the wheels 306 in the direction ‘X’. In operation, the pipe may be pressurised by any suitable means, for example, by a fan (not shown) located in a sealed stop (not shown) at a rear end of the pipe relative to the direction ‘X’.

The rig 300 is connected to a winch (not shown) via a cable 314, trailing behind the device into the pressurised region. Hence, in operation, the cable may be played out at a predetermined rate, thereby to control the velocity of the rig along the pipe 12 under the pressure created by the pressurising means.

The air pressure behind the rig 300 also acts to force the containment layer 18, and structural layers 14, 16 against the inner surface of the host pipe 12. This helps to ensure that the corresponding welding surfaces are kept in pressure contact during welding, and that any distortion of the lining during welding and subsequent cooling is substantially reduced.

The seam welding and sheet welding portions 308, 310 each comprise at least one infrared lamp 316, 318, directed radially outwardly, for respective welding of the containment layer seam 302, and of the containment layer 18 to the underlying structural layer 16. It will be appreciated that the welding of the containment layer 18, to the structural layer 16 may be completed in any suitable pattern, for example, as a continuous line weld or as an intermittent spot weld or the like. In operation, the welding surfaces and the associated region are cooled by allowing air 320 to bleed over the weld surfaces and through the welding portions 308, 310, and other rig members to a low pressure side of the shield.

It will be appreciated that although FIG. 14 shows a single sheet welding portion 310 and FIGS. 15 and 16 show two, there may be any suitable number of welding portions 310. Typically, for example, there will be 4 to 10 sheet welding portions, depending on the diameter of the pipe, evenly distributed relative to the internal circumference of the composite lining 10.

Referring, in particular, to FIGS. 15 and 16, the seam 302 comprises internal and external overlapping layers 324, 326, formed from the longitudinal edge regions of the tubular containment layer 18, as generally described previously. The innermost layer 324 is infrared transparent, whilst the outermost overlapping layer 326 has an absorption surface 328 located at the interface between the layers 324, 326. Hence, in operation, the absorption surface 328 absorbs the infrared radiation directed through the innermost layer 324 of the seam 302 to heat, melt and weld the overlapping layers 324, 326 to one another at the interface.

The rig 300 is further provided with a bearing 322 to which the welding portions 308, 310 are connected. The bearing 322 is arranged for longitudinal alignment with a central axis of the pipe 12 such that in operation the welding portions 308, 310 are rotatable relative to the rig 300, and the pipe 12, about the central axis. Thus, the rotational position of the seam welding portion 308 may be automatically adjusted, in operation, to allow it to follow the seam, along the pipe using mechanical or electrical sensors and appropriate electromechanical control systems.

The seam welding portion 308 is further provided with an optional pressurising fan 330 and at least one additional sliding seal (not shown). The fan 330 and the or each seal is arranged to form a localised seam weld region, which may be pressurised independently by the fan 330. Hence, in operation, the air fan 330 provides additional pressure to the area of the seam 302 being welded and also a means of cooling the infrared elements and weld surfaces. As best seen in FIG. 16, this creates a better contact between the overlapping layers 324, 326, during the seam welding operation, thus improving the quality of the weld.

Alternatively, a sealed membrane (not shown) could be fitted over the edges of the seam welding portion 306 to exert additional pressure on the welding overlap 324, 326 as the rig 300 travels along the seam. Ally such membrane would need to be both transparent to infrared, and heat resistant to prevent damage arising from the heat of the weld. For example, the membrane could be made of transparent polyester or other such suitable material.

It will be appreciated that without local pressurization the seam surfaces may, in some instances, only make a line contact rather than a full contact across the width of the seam.

Verification of the welding process is carried out CCTV cameras (not shown) onboard the rig and/or by later inspection. Good continuous welds are indicated by distinctive colour change of the welded area. On completion of the lining process, purpose made couplings are connected or fusion welded to the ends of the lining and the lined section pressure tested and leak tested in accordance with the appropriate regulations.

In FIG. 17 an alternative seam welding portion, for the welding rig is shown generally at 340. The seam welding portion 340 is generally similar to the welding portion 308 described with reference to FIGS. 14 to 16. Hence, it will not be described again in detail other than to highlight differences.

The seam welding portion 340 comprises an infrared shield 342 located between the infrared lamp and the seam 302. The shield 342 is configured to protect a central portion 344 of the seam 302 from the infrared radiation, in effect splitting the infrared radiation into two distinct beams or regions. Hence, in operation, the seam welding operation results in two substantially parallel continuous welds 346, spaced apart by a distance determined by the width of the shield. Thus, the region 348 between the parallel welds 346 forms a substantially enclosed conduit, bordered by the overlapping layers 324, 326 and the welds 346.

In operation, therefore, the conduit 348 may be used in a verification test for seam integrity, by pressurising the conduit 348 to assist in detecting the presence of leaks anywhere along the full length of the seam.

This represents a particularly advantageous configuration because the gas and liquid containment integrity of the lining is dependent on the integrity of the welded seam. The verification test may, for example, be carried out during acceptance tests of the completed lining.

The basic testing procedure involves substantially sealing the conduit 348 at both ends of the newly lined section. Air flow, along the passage is subsequently checked before the conduit is pressurised using any suitable means. Any leaks detected are generally indicative of a problem with at least one of the seam welds. Conversely, the absence of a leak confirms that both welds are satisfactory and hence the seam is verified as sound.

In FIG. 18 a section of an alternative configuration of an infrared double welded seam is shown generally at 350. The double welded seam 350 is seam welded generally in the manner described with reference to FIG. 17. However, the inner overlapping layer 324 is further provided with a recess 352, extending longitudinally the full length of the seam. Hence, when the seam welding operation is completed the resulting conduit 354 has a larger cross-sectional area than the conduit 348 described with reference to FIG. 17.

It will be appreciated that in practice, where infrared welding is used, the cross-sectional area of the smaller conduit 348 is adequate for the verification test, due to distortion arising from localised heating during welding.

It will be appreciated that although infrared techniques are described in detail, other suitable methods for seaming the containment layer, and for bonding the composite pipe components to one another are possible.

One such method, for example, uses ultrasound. The ultrasound technique may be implemented using an air pressurised pipe traversing rig similar to that described with reference to FIG. 14 in particular.

A typical ultrasound rig, for example, is fitted with ultrasonic welding tools which radiate ultrasonic vibrations though the internal overlapping layer 324 to weld the seam 302, and through selected regions of the containment layer 18 to weld it to the underlying helically wound structural layer 16. For successful ultrasonic welding, the liner materials are preferably thermoplastic, so that the ultrasonic vibrations induce a thermal rise at the bonding interface which heats, melts and welds the appropriate component parts. In some applications ultrasound bonding is faster than infrared techniques. Furthermore, ultrasound bonding is particularly advantageous for welding thicker containment layers because ultrasonic vibrations can generally penetrate deeper than infrared radiation. However, the ultrasound method requires a higher pressure contact between the containment and structural layers.

Another method of bonding the composite pipe components is by electrofusion, which is a common method of bonding fittings to thermoplastic pipes and the like. Electrofusion involves resistively heating wires embedded at the interface between two welding surfaces, by passing an appropriate electric current through them. In conventional electrofusion systems the wires are located in the surfaces to be bonded during manufacture. The surfaces are subsequently brought together and the wires heated using a predetermined current, for a predetermined time period, sufficient to ensure that the interface surfaces melt and mechanically bond together.

Application of electrofusion to the lining of pipes with the composite linings described, involves embedding wires at appropriate places in the containment layer during manufacture. Subsequently, the containment layer is arranged in tubular form and positioned in a host pipe as generally described previously. Air pressure is then used to force the tube onto the inner surface of the structural layer using an inflatable tubular bladder or the like. Electrical connections are made to exposed ends of the embedded wires and the fusion welding process carried out substantially simultaneously for the whole lining.

Electrofusion is advantageous because it is independent of the thickness of the sheet and is very quick to weld. However, the manufacturing process for the containment layer is necessarily more complex, because of the requirement for heating wires to be carefully preinstalled in the surface of the sheet material sheet in factory conditions.

In FIG. 19 a section of an electrofusion double welded seam is shown generally at 360. The internal overlapping layer 324 has a recess 352 provided along its longitudinal length as generally described with reference to FIG. 17. Embedded wires 362, are provided longitudinally adjacent the recess 352, for seam welding the sheet tube and sealing the resulting conduit 354. As described previously, after welding, dark lines on the surface of the internal overlapping layer 324 are indicative that the welding process has been successful, provided the thickness of the sheet is not too great.

In FIG. 20, a service connection for connecting customer pipes to a supply pipeline lined with a composite lining is shown generally at 400. The connection 400 comprises a connection tapping having a body portion 402, a retaining portion 404, and a fixing portion 406. The tapping 400 is shown in position on a pipe 12, the pipe being lined with a composite lining 10a according to the first embodiment. It will be appreciated, however, that the tapping has similar utility for pipes having any other suitable lining including a composite lining as described for the second, third, fourth or fifth embodiments. The tapping 400 is generally similar to connection tappings for conventional connectors for connecting to water or gas pipes lined with polyethylene linings or the like.

The body portion 402 comprises a generally elongate tubular conduit configured for insertion through a suitable aperture, provided in the pipe 12, and for screwing into and through the wall of the composite lining 10a, thereby to provide fluid access to and/or from the pipe. The retaining portion 404 comprises an expanding washer or cone, which in operation, may be pushed through the lining 10a, to retain the tapping against an inside surface of the composite lining 10.

The fixing portion 406 comprises any suitable means for tightly securing the tapping 400 in the pipe and for providing a fluid impermeable seal, with the inner containment layer, around the tapping. Typically, for example, the fixing portion comprises a nut, which in operation is threaded onto a mutually engaging threaded portion of the body 402 protruding externally from the pipe 12. The nut 406 is then, in operation, tightened against the pipe to clamp the pipe between the nut 406 and the retaining portion 404, thereby to secure the tapping 400 in place and provide a substantially fluid impermeable seal. In operation, a customer connection may then be made to the fitting 400 using any suitable valve.

Connection tappings are typically fitted either when the pipe is not in use or when working under pressure. Connection to the pipe is generally made at the top of the pipe to provide easy access and to avoid any liquid (in the case of gas pipes) or solid contaminants, which may accumulate at the bottom of the pipe.

Service connections to supply gas or liquid to users have to be disconnected before lining commences and then reconnected after lining. These connections are normally accessed via access pits and use special fertile connectors to seal to the lining within the host pipe. This type of expanding ferrule connector is particularly suited to making service connections to the composite lining described. Since service connections are normally made to the top of the host pipe it is preferable that they avoid the seam of the sheet tube. This can be achieved at installation by ensuring the seam is located at the bottom of the host pipe.

Installation of thermoplastic, such as polyethylene, linings are normally carried out between access pits where short sections of the host pipe have been cut out to allow installation access. After completion of a lining section the ends of the lined pipe sections have to be rejoined in the access pit. This requires end connections to be made to the linings to enable short sections of connecting pipe to be installed. In the case of connections for normal polyethylene linings, polyethylene flanges are commonly heat fusion welded to the pipe lining ends. This fusion jointing method is particularly suited for the connection of the composite linings described, to standard polyethylene pipe inserts. The fusion process welds the flange to the lining, and also welds the layers of the composite lining together thereby giving a fully structural termination to the lining.

In FIG. 21, an end connection system is shown generally at 450. The connection arrangement 450 allows sections of lined pipe either to be connected to one another, or to be connected to an unlined section of host pipe.

The connection arrangement 450 is generally similar to the system described for conventional polythene pipes. The arrangement 450 comprises an annular flanged portion 452 of greater external diameter than that of the pipe 12, and of internal diameter equivalent to that of the composite lining. In operation the flanged portion 452 is aligned generally coaxially with an exposed end of the composite lining 10a, and fixed using a suitable bonding process such as fusion welding or the like. During the fixing operation the end of the composite lining to which the flange 452 is fixed may project from the end of the host pipe 12, as seen in FIG. 21, to allow it to be clamped and prepared for fusion welding. In operation, all layers of the lining are welded, at the exposed end, both to the flange, and to each other to make a fully structural fluid impermeable connection.

The flanged portion 452, further comprises a plurality of bolt holes 454 arranged evenly around its circumference, for allowing it to be interconnected with a corresponding flange of another lined pipe section or an unlined section of host pipe.

It will be appreciated that the structural qualities of the composite lining compare with standard thermoplastic pipes of similar wall thickness and the flexible design using basic materials lends itself to the lining of large diameter pipes.

For example, calculations show that composite polyethylene liner comprising spiral strip and sheet layers have a pressure capability only a few percent less than the equivalent standard polyethylene pipe with the same wall thickness. The embodiments of the composite liner described can be used to line medium, large and very large diameter pipes, of up to at least 96 inches, with wall thickness matching SDR11 to SDR26 specifications and above. They may be installed in lengths between access pits spaced up to 1500 m apart. Close fit linings for variable pipe diameters can be achieved and bends negotiated even where the radius of curvature is relatively small, for example, 20 pipe diameters. Hence, the invention provides an extremely versatile pipe lining system with installation advantages and which only uses relatively low-cost basic materials.

The versatility of the composite structure allows it to be reinforced with alternative or additional helical layers wound with other materials such as high performance plastic, fibre reinforced thermoplastic, filament woven braid or metal strip. This choice of helical strip materials enables composite linings to be designed to a much higher specification than standard pipes or normal pipe linings.

An alternative to the seamed containment layer internal lining is to insert an extruded seamless thin wall thermoplastic pipe into the pipe being lined, and to subsequently bond this to the underlying structural layer in the same manner as the seamed tube. This thin walled tube could be supplied in lay flat form on a roll, inserted in a folded form, expanded to fit the lining by the pressurised welding rig and then welded to the underlying spiral wound layer as previously described.

An alternative to the structural helical layers is to insert short lengths of thick walled pipe section in various folded forms to enable them to pass down the pipe on a travelling rig that will insert them to provide a substantially continuous internal structural lining. The sections may then be bonded to the thin sheet lining to give a composite structure with a pressure rating equivalent to standard pipes.

In a pipeline with many irregularities it is particularly difficult to seam weld reliably when the overlapping welding surfaces are distorted prior to welding and may not be in continuous contact even under high pressure. The composite liners proposed provide a solution, which substantially mitigates this problem by pre-lining the pipe to produce a relatively smooth underlying surface, whilst also providing structural support to the thin walled containment layer. The helically wound structural layers, in particular, provide this smoothing property in combination with the structural properties required of the lining.

It will be appreciated that although pipelines are thoroughly cleaned prior to lining the welding surfaces of the containment layer have to be kept clean to guarantee the quality of the welded seam. There are a number of ways to protect the cleanliness of the containment layer sheet material during the installation process. One method is to wrap the containment layer tube with plastic film before the tube is drawn into the host pipe. Advantageously, this wrapping can also be used to confine the diameter of the tube to enable easier insertion into the host pipe. The wrapping may be subsequently removed using the pressurised welding rig described with reference to FIG. 14, either by bursting the wrapping using air pressure, or alternatively by cutting it using a specialised attachment. Hence, the tube is allowed to expand into contact with the pipe wall.

An alternative method for protecting the overlapping seam, is to bond a protection film across the internal and external edges of the containment layer tube, prior to insertion into the host pipe. This method completely protects the seam welding surfaces because the film can be left in place during the welding process. In practice, for most applications, it is unlikely that such wrapping will be required to keep the welding surfaces clean, because the structural layers provide a protective barrier inside the host pipe, and therefore a clean environment for welding.

The welding process may alternatively be carried out using a substantially infrared transparent pressurised air bladder, which is used to expand the composite liner components tightly onto the inside wall of the host pipe. Welding is then achieved using infrared lamps, which radiate short wave infrared energy though the walls of the bladder and the thin inner containment layer, to seam weld the overlapping seam and, if required, to bond selected areas of the containment layer to any underlying structural layer.

It will be appreciated that the term pipe is intended to be construed broadly to cover any conduit for bearing fluid.

1-43. (canceled)

44. A method of lining a pipe comprising:
lining said pipe with a structural layer for providing structural integrity; and
lining said pipe with a containment layer for providing fluid impermeability;
wherein, lining said pipe with said structural layer comprises introducing at least one strip to said pipe, and arranging the or each said strip to form a substantially continuous lining within said pipe.

45. A method of lining a pipe as claimed in claim 44, wherein lining said pipe with said containment layer comprises arranging at least one section of sheet lining material to form a tubular lining and seaming said tubular lining to render it substantially impermeable.

46. A method of lining a pipe as claimed in claim 44, wherein the containment layer is provided concentrically within the structural layer the containment layer being bonded to at least a portion of an internal surface of the structural layer.

47. A method of lining a pipe as claimed in claim 44, wherein the containment layer is provided concentrically outside the structural layer.

48. A method of lining a pipe as claimed in claim 44, wherein lining said pipe with a structural layer comprises helically winding the or each strip to form a plurality of turns, each turn being in substantial helical contact with the previous turn thereby forming a substantially continuous tubular structural layer within said pipe.

49. A method of lining a pipe as claimed in claim 44, wherein the structural layer is a first structural layer, and the method further comprises lining the pipe with a further structural layer, the further layer comprising at least one further strip of said structural lining material arranged to form a substantially continuous lining within said pipe.

50. A method of lining a pipe as claimed in claim 49, wherein lining said pipe with said further structural layer comprises helically winding the or each further strip to form a plurality of turns, each turn being in substantial helical contact with the previous turn thereby forming a substantially continuous tubular structural layer within said pipe.

51. A method of lining a pipe as claimed in claim 49, wherein the first structural layer is provided concentrically within the further structural layer.

52. A method of lining a pipe as claimed in claim 49, wherein:
lining the pipe with a first structural layer comprises helically winding the or each corresponding strip in a first helical direction to form a substantially continuous tubular lining within said pipe; and
and lining the pipe with the further structural layer comprises helically winding the or each further strip in a second helical direction to form a substantially continuous tubular lining within said pipe;
wherein, the first and second helical directions are opposite.

53. A method of lining a pipe as claimed in claim 44, wherein the containment layer is a first containment layer, and the method further comprises lining the pipe with a further containment layer by arranging at least one further section of lining material to form a tubular lining and seaming said tubular lining to render it substantially impermeable.

54. A method of lining a pipe as claimed in claim 53, wherein the or at least one structural layer is provided between the first and further containment layers.

55. A method of lining a pipe as claimed in claim 44, wherein the method further comprises lining the pipe with at least three containment layers and at least two structural layers, the containment layers being separated from one another by a corresponding structural layer.

56. A method of lining a pipe as claimed in claim 44, wherein the method further comprises:
providing a test structure for testing the fluid impermeability of said containment layer of a composite lining said structure comprising:
a seam provided along a longitudinal length of said containment layer, the seam comprising at least two substantially parallel seamed regions;
and a conduit formed between said seamed regions.

57. A method of lining a pipe as claimed in claim 56, wherein the method further comprises:
testing the fluid impermeability of said containment layer
by pressurising said conduit with a fluid; and
determining if said fluid is leaking from either of said parallel seamed regions.

58. A composite lining for a pipe produced by the method according to claim 44, comprising:
at least one structural layer for providing structural integrity, the structural layer comprising at least one strip of structural lining material arranged to form a substantially continuous lining within said pipe; and
at least one containment layer for providing fluid impermeability.

59. A composite lining as claimed in claim 58, wherein the containment layer comprises at least one section of lining material arranged to form a substantially continuous impermeable tubular lining within said pipe.

60. A composite lining as claimed in claim 58, wherein the containment layer is provided concentrically within the structural layer the containment layer being bonded to at least a portion of an internal surface of the structural layer.

61. A composite lining as claimed in claim 58, wherein the containment layer is provided concentrically outside the structural layer.

62. A composite layer as claimed in any of claims 58, wherein the structural layer comprises the or each strip helically wound to form a plurality of turns, each turn being in substantial helical contact with the previous turn thereby forming a substantially continuous tubular lining within said pipe.

63. A composite lining as claimed in claim 58, wherein the structural layer is a first structural layer, and the composite lining is provided with a further structural layer, the further layer comprising at least one strip of lining material arranged to form a substantially continuous lining within said pipe.

64. A composite lining as claimed in claim 63, wherein the further structural layer comprises at least one further strip helically wound to form a plurality of turns, each turn being in substantial helical contact with the previous turn thereby forming a substantially continuous tubular lining within said pipe.

65. A composite lining as claimed in claim 63, wherein the first structural layer is provided concentrically within the further structural layer.

66. A composite lining as claimed in claim 63, wherein:
the first structural layer comprises the or each corresponding strip helically wound in a first helical direction to form a substantially continuous tubular lining within said pipe; and
the further structural layer comprises the or each further strip helically wound in a second helical direction to form a substantially continuous tubular lining within said pipe;
and wherein, the first and second helical directions are opposite.

67. A composite lining as claimed in claim 58, wherein the containment layer is a first containment layer, and the composite lining is provided with a further containment layer, the further containment layer comprising at least one section of lining material arranged to form a substantially impermeable tubular lining within said pipe.

68. A composite lining as claimed in claim 67, wherein the or at least one structural layer is provided between the first and further containment layers.

69. A composite lining as claimed in claim 58, comprising at least three containment layers and at least two structural layers, the containment layers being separated from one another by a corresponding structural layer.

70. An apparatus for providing a loosely twisted helical strip of lining material for lining a pipe, the apparatus comprising:
a base portion; and
coil support means rotatably mounted on said base portion for supporting a coil of said lining material and for allowing a strip of said lining material to be dispensed from said coil;
the coil support means being rotatable in a controlled manner relative to said base portion for inducing helical twists in said strip of lining material.

71. An apparatus as claimed in claim 70, wherein:
said coil support means is configured to dispense said strip from a centermost end of said coil, thereby allowing a strip with a naturally induced helical twist to be dispensed;
said naturally induced twist being additional to any rotation induced twist.

72. An apparatus as claimed in claim 70, wherein:
said coil support means is provided with a strip dispensing portion comprising an aperture for dispensing said strip through;
said strip dispensing platform being rotatable independent of said coil support means relative to said base portion.

73. An apparatus as claimed in claim 70, wherein:
said coil support means is rotatably mounted on said base portion for rotation about the axial centre of said coil.

74. An apparatus as claimed in claim 70, wherein:
said coil support means is rotatably mounted on said base portion for rotation about an axis substantially perpendicular to the axial centre of said coil.

75. An apparatus for helically lining a pipe with a strip of lining material, the apparatus comprising:
a winding rig comprising helical winding means;
said helical winding means being configured for helically winding said strip into a helically wound lining layer for lining an inside surface either of said pipe or of a previously laid lining layer.

76. An apparatus for helically lining a pipe as claimed in claim 75, wherein
said winding means is configured for helically winding said strip directly onto said inside surface;
and said winding rig is configured for longitudinal travel along said pipe as each turn of said helically wound lining layer is formed on said inside surface.

77. An apparatus for helically lining a pipe as claimed in claim 75, wherein
said winding means is configured for helically winding said strip directly onto said inside surface;
and said winding rig is configured for free rotation about a longitudinal axis of said pipe as each turn of said helically wound lining layer is formed on said inside surface.

78. An apparatus for helically lining a pipe as claimed in claims 75, wherein
said winding means is configured for winding said lining strip into a helically wound portion layer, and for driving said helically wound tubular portion along said pipe thereby to form said helically wound lining layer on said inside surface.

79. An apparatus for helically lining a pipe as claimed in claims 75, wherein said winding means comprises:
a cylinder rotatably mountable on an end of said pipe for winding said lining strip onto an internal surface thereof thereby to form said helically wound portion;
and a helical guide mounted on said internal cylinder surface for driving said helically wound portion along said pipe thereby to form said helically wound lining layer on said inside surface either of said pipe or of a previously laid lining layer.

80. An apparatus for lining a pipe with a tubular containment layer comprising:
a formation portion comprising at least one rounding die for forming a sheet of lining material into a substantially cylindrical tubular structure.

81. An apparatus as claimed in claim 80, wherein the formation portion further comprises:
at least one formation die for forming a sheet of lining material into a flattened tubular structure;
the rounding die being located for forming said flattened tubular structure into said substantially cylindrical tubular structure.

82. A welding apparatus for seam welding a containment layer in a pipe, the apparatus comprising:
a mobile unit configured for longitudinal travel down said pipe;
said mobile unit comprising at least one seam welding head for welding a seam of said containment layer.

83. A welding apparatus as claimed in claim 82, wherein the mobile unit further comprises at least one further welding head for welding said containment layer to an underlying structural layer.

84. A welding apparatus as claimed in claim 82, wherein the or each welding head comprises an infra-red source for inducing heat thereby to cause said welding.

85. A welding apparatus as claimed in claim 82, wherein the or each welding head comprises an ultrasound source for inducing heat thereby to cause said welding.

86. A welding apparatus as claimed in claim 82, wherein the or each seam welding head includes a pressurising fan for applying air pressure to said seam during welding.

87. A welding apparatus as claimed in claim 82, wherein the or each seam welding head comprises a shield portion for preventing a longitudinal portion of said seam from being welded, thereby to form a fluid impermeable conduit.
